(19) United States
(12) Patent Application Publication
(10) Pub. No.: US 2023/0206308 A1
(43) Pub. Date: Jun. 29, 2023

(54) AUTOMATED CART GENERATION

(71) Applicant: DoorDash, Inc., San Francisco, CA (US)

(72) Inventors: Matthew Johnathan Fan, San Francisco, CA (US); Indhu Kamala Kumar, San Mateo, CA (US); Satish Subhashrao Saley, Fremont, CA (US); Jingyi Deng, San Leandro, CA (US)

(73) Assignee: DoorDash, Inc., San Francisco, CA (US)

(21) Appl. No.: 18/147,801

(22) Filed: Dec. 29, 2022

Related U.S. Application Data
(60) Provisional application No. 63/294,457, filed on Dec. 29, 2021.

(51) Int. Cl. G06Q 30/0601

(52) U.S. Cl. CPC G06Q 30/0633; G06Q 30/0631

(57) ABSTRACT

A server computer obtains a plurality of user features, a plurality of service provider features, and a model. The server computer inputs the plurality of user features and the plurality of service provider features into the model. The server computer updates the model to form an updated model. The server computer determines a plurality of carts using the updated model. Each cart of the plurality of carts includes one or more items. The server computer provides one or more carts of the plurality of carts to an end user device. The server computer receives a selection of a cart of the one or more carts or a modification thereof. The server computer processes the selection by facilitating preparation and delivery of the one or more items in the cart. The server computer updates the updated model using data related to the cart to form a subsequent model.

### CROSS-REFERENCES TO RELATED APPLICATIONS

The present application is a Non-Provisional application of and claims priority to U.S. Provisional Application 63/294,457, filed on Dec. 29, 2021, which is incorporated herein by reference in its entirety.

### SUMMARY

One embodiment is related to a method comprising: obtaining, by a server computer, a plurality of user features, a plurality of service provider features, and a model; inputting, by the server computer, the plurality of user features and the plurality of service provider features into the model; updating, by the server computer, the model to form an updated model; determining, by the server computer, a plurality of carts using the updated model, wherein each cart of the plurality of carts includes one or more items; providing, by the server computer, one or more carts of the plurality of carts to an end user device; receiving, by the server computer, a selection of a cart of the one or more carts or a modification thereof; processing, by the server computer, the selection by facilitating preparation and delivery of the one or more items in the cart; and updating, by the server computer, the updated model using data related to the cart to form a subsequent model.

Another embodiment is related to a server computer comprising: a processor; and a computer-readable medium coupled to the processor, the computer-readable medium comprising code executable by the processor for implementing a method comprising: obtaining a plurality of user features, a plurality of service provider features, and a model; inputting the plurality of user features and the plurality of service provider features into the model; updating the model to form an updated model; determining a plurality of carts using the updated model, wherein each cart of the plurality of carts includes one or more items; providing one or more carts of the plurality of carts to an end user device; receiving a selection of a cart of the one or more carts or a modification thereof; processing the selection by facilitating preparation and delivery of the one or more items in the cart; and updating the updated model using data related to the cart to form a subsequent model.

Another embodiment is related to method comprising: providing, by an end user device, one or more user features to a server computer, wherein the server computer inputs the one or more user features and a plurality of service provider features into a model, updates the model to form an updated model, and determines a plurality of carts using the updated model, wherein each cart of the plurality of carts includes one or more items; receiving, by the end user device, one or more carts of the plurality of carts from the server computer; obtaining, by the end user device, a selection of a cart of the one or more carts or a modification thereof; and providing, by the end user device, the selection of the cart to the server computer, wherein the server computer processes the selection by facilitating preparation and delivery of the one or more items in the cart and updates the updated model using data related to the cart to form a subsequent model.

Further details regarding embodiments of the disclosure can be found in the Detailed Description and the Figures.

### BRIEF DESCRIPTION OF THE DRAWINGS

FIG. 1 shows a block diagram of a cart generation system according to embodiments.

FIG. 2 shows a block diagram of components of a central server computer according to embodiments.

FIG. 3 shows a block diagram of components of an end user device according to embodiments.

FIG. 4 shows a hybrid diagram illustrating a cart generation method according to embodiments.

FIG. 5 shows a hybrid diagram illustrating a machine learning training and cart generation process according to embodiments.

FIG. 6 shows a flow diagram illustrating a preparation and delivery method according to embodiments.

FIG. 7 shows a user interface diagram illustrating a cart suggestion process according to embodiments.

FIG. 8 shows a user interface diagram illustrating a generated cart according to embodiments.

FIG. 9 shows a user interface diagram illustrating multiple generated carts according to embodiments.

FIG. 10 shows a flow diagram illustrating a cart generation and provisioning method according to embodiments.

FIG. 11 shows a graph illustrating the length of time it takes to place an order according to embodiments.

### DETAILED DESCRIPTION

A large number of end users that want to make purchases spend a significant time deciding what to order. For example, in the food delivery context, end users can spend 19 minutes on average looking at purchase options before placing an order). Currently, food delivery platforms suggest restaurants to end users when the end user is searching for restaurants. Once the end user selects a restaurant, food delivery platforms can suggest individual items from the restaurant to the end user. The end user can select an add to cart option to add the item to their current cart.

These current approaches of suggesting restaurants and individual items both have the limitations of being too broad and undirected. Restaurant suggestions still present too many options which again may overwhelm the users. For example, it is estimated that there are over 4,400 restaurants in the city of San Francisco. Additionally, suggesting individual food items is only feasible once the customer selected a restaurant, and thus this does not help the customer narrow down their food choices. Both of these existing flows also require a significant amount of actual user inputs before the user can check out (e.g., selecting a restaurant, selecting individual items, checking out, etc.) which can further degrade the overall general user experience and can unnecessarily consume computing resources.

Embodiments of the disclosure address this problem and other problems individually and collectively.

Prior to discussing embodiments of the disclosure, some terms can be described in further detail.

A “user” may include an individual or an entity. In some embodiments, a user may be associated with one or more personal accounts and/or mobile devices. In some embodiments, the user may be a consumer.

A “user device” may be any suitable electronic device that can be used by a user. An exemplary user device can process and communicate information to other electronic devices. The user device may include a processor and a computer-readable medium coupled to the processor, the computer-readable medium comprising code, executable by the processor. The user device may also each include an external communication interface for communicating with other entities. Examples of user devices may include mobile devices such as mobile phones and laptop computers, wearable devices (e.g., glasses, rings, watches, etc.), hardware modules in larger devices such as vehicles (e.g., automobiles), etc.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a partially completed state, or a final state. After the fulfillment request is in a final state, it can be accepted by the central server computer, and the central server computer can send a fulfillment request confirmation to the end user device. A fulfillment request can include one or more selected items from a selected service provider. A fulfillment request can also include user features of the end user providing the fulfillment request.

A “cart” can include software that records items selected by a user for purchase until a transaction is completed. A cart can be an ecommerce shopping cart, which can be a type of software that allows end users to purchase items from a service provider or store a list of items the end user wants to purchase in the future. A cart including one or more items can be generated by a central server computer.

An “item” can include an individual article or unit. An item can be a thing that is provided by a service provider. Items can be a goods. For example, an item can be a bowl of soup, a soda can, a toy, clothing, etc. An item can be a thing that is delivered from a service provider location to an end user location by a transporter.

A “feature” can be an individual measurable property or characteristic of a phenomenon. A feature can be described by a feature vector. A feature can be input into a model to determine an output. As an example, in pattern recognition and machine learning, a feature vector is an n-dimensional vector of numerical features that represent some object. Algorithms in machine learning require a numerical representation of objects since such representations facilitate processing and statistical analysis. When representing images, the feature values might correspond to the pixels of an image. When representing text, however, the features might be the frequencies of occurrence of textual terms. Feature vectors are equivalent to the vectors of explanatory variables used in statistical procedures such as linear regression. Feature vectors can be combined with weights using a dot product in order to construct a linear predictor function that is used to determine a score for making a prediction.

“User features” can include attributes or aspects of a user. User features can include features that relate to a user. User features can include order history, delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the user.

“Service provider features” can include attributes or aspects of a service provider. Service provider features can include features that relate to a service provider.

Service provider features can include service provider details, cuisine, ratings, food category, service provider location(s), item production time, promoted items, item cost, and/or other data representative of the service provider and/or items provided by the service provider.

The term “artificial intelligence model” or “machine learning model” can include a model that may be used to predict outcomes to achieve a pre-defined goal. A machine learning model may be developed using a learning algorithm, in which training data is classified based on known or inferred patterns.

“Machine learning” can include an artificial intelligence process in which software applications may be trained to make accurate predictions through learning.

The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “model” can include a computer program that is designed to simulate what might occur in a situation given various inputs. A model can be a machine learning model. A model can receive input data and determine an output. User features and service provider features can be input into a model to determine an output of a cart.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

End users can order items from a service provider via a central server computer. Items can be added to the carts. For example, an end user can add items to a cart and submit the cart to the central server computer for processing in a transaction. The central server computer can communicate with a service provider computer and a transporter user device to process and deliver the items in the cart to the user.

Embodiments relate to automated cart generation for efficient checkout. Embodiments allow the end user to select from automatically generated carts for purchase. The central server computer can generate a plurality of carts (e.g., a plurality of carts filled with items to purchase) based on user features and service provider features using a model. The central server computer can indicate a service provider associated with the cart (e.g., a specific merchant) and one or more items provided by the service provider. The service provider can operate a service provider computer. The central server computer can provide one or more of the plurality carts to the end user device. In some embodiments, the central server computer can provide one or more carts to the end user device at any point in time. In other embodiments, the end user device can request one or more carts from the central server computer. Each can be automatically generated using data to predict carts that have high relevance to the end user. The end user, upon selecting a generated cart, is then brought directly to a checkout page on the end user device.

In some embodiments, the end user can be presented with a mechanism (e.g., a button) that allows the end user to select a new cart including different items. Further, in some embodiments, the end user can edit and/or customize the cart after generation. For example, the end user can add new items to the generated cart or can remove items from the generated cart.

The central server computer can generate the carts using a machine learning model, such as a machine learning recommendation engine. The machine learning model can utilize user features of the end user. The user features can include dietary preferences, historical ordering data, ratings, saved service providers, current order location, etc. Furthermore, the machine learning model can be further customized based on session specific variables, such as, users particular predispositions to something on a particular day (e.g., the end user has spent 10 minutes browsing a particular food category), the number of people that will receive the service (e.g., 5 people will be eating the ordered food), food category preferences, budget preferences, delivery estimated times of arrival, current end user locations, etc. In some embodiments, these variables could be omitted or presented as optional to the end user for custom user input. Further variables can include cart variability, item presentation order, and biases for certain variables like service provider preparation times, cuisine types, historical data on items that have been chosen or rejected in the past from previously auto-generated carts, etc.

The machine learning model can further utilize aggregated platform data, for example, the most popular restaurants, the most commonly placed carts, the most commonly selected items, etc. The machine learning model can additionally be used to cluster similar users to help optimize the suggestion engine for those users. The machine learning model can also allow the central server computer to make good predictions for users with minimal or no historical ordering data.

The generated carts can be provided from a central server computer to an end user device. Also, the central server computer can perform the processing and determination of the carts. Once they are determined, the central server computer can provide one or more carts to the end user device. For example, the central server computer can provide a preset number of suggested carts in a predetermined sequence to the end user of the user device. In some embodiments, the predetermined sequence can be in the order of cart relevance.

To minimize decision paralysis and avoid overwhelming the user, carts can be individually presented to the user. If the user does not like a presented cart, the user can switch to the next suggested cart in the queue. This helps to eliminate duplicate or similar carts from showing up in a given session. The user also has control over how carts are presented.

Various embodiments reduce the number of clicks, interactions, and decisions an end user needs to perform when ordering one or more items from a service provider. For example, in some cases, a cart can be generated with a particular restaurant's most popular items, where the restaurant serves the food type that is most often ordered by the end user. The carts that are created according to embodiments can be provided to the user on demand and can reduce steps and processing associated with a purchase transaction.

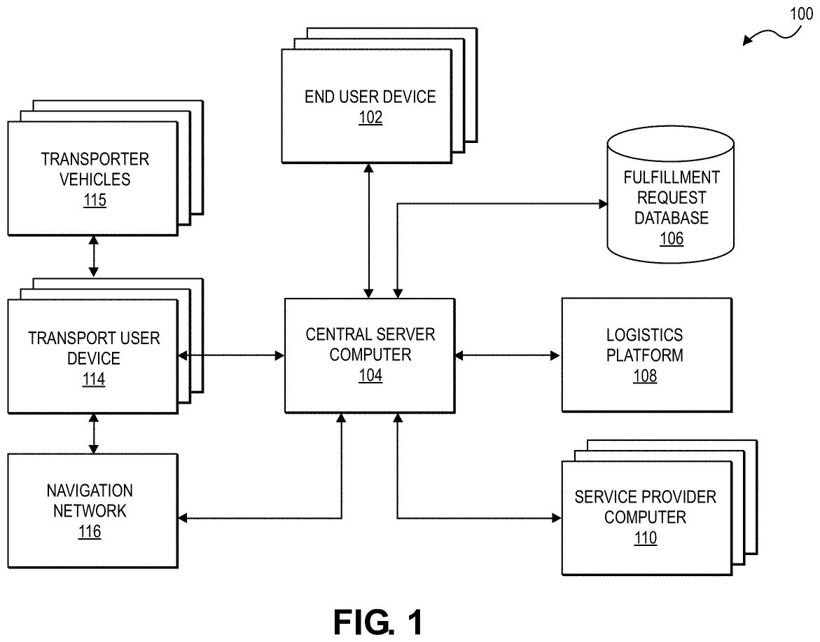

FIG. 1 shows a system 100 according to embodiments of the disclosure. The system 100 comprises one or more end user devices 102, a central server computer 104, a fulfillment request database 106, a logistics platform 108, one or more service provider computers 110, one or more transporter user devices 114, and a navigation network 116. One or more transporter vehicles 115 are also shown. A transporter can operate a transporter user device 114 and a transporter vehicle 115. For example, a transporter can be a delivery person, the transporter user device 114 can be the delivery person's mobile phone, and the transporter vehicle 115 can be a car that is operated by the delivery person.

The central server computer 104 can be in operative communication with the one or more end user devices 102, the fulfillment request database 106, the logistics platform 108, the one or more service provider computers 110, the transporter user device 114, and in some embodiments, the navigation network 116. Further, the one or more transporter user devices 114 can be in operative communication with the navigation network 116.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between at least the devices in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The one or more end user devices 102 includes devices operated by end users. The one or more end user devices 102 can generate and provide fulfillment request messages to the central server computer 104. The fulfillment request message can indicate that the request (e.g., a request for a service) can be fulfilled by one or more service provider computers 110. For example, the fulfillment request message can be generated based on a cart selected at checkout during a transaction using a central server computer application installed on the end user device 102. The fulfillment request message can include one or more items from the selected cart.

The central server computer 104 includes a server computer that can facilitate in the fulfillment of fulfillment requests received from the one or more end user devices 102. For example, the central server computer 104 can identify one or more transporters operating one or more transporter user devices 114 that are capable of satisfying the fulfillment request. The central server computer 104 can identify the transporter user device 114 that can satisfy the fulfillment request based on any suitable criteria (e.g., transporter location, service provider location, end user destination, end user location, transporter mode of transportation, etc.). The logistics platform 108 may provide real time data regarding locations of the various service providers, transporters, and end users to the central server computer 104.

The central server computer 104 can generate a plurality of carts for an end user. The plurality of carts can include one or more items from service providers that can be ordered by the end user. The central server computer 104 can obtain a plurality of user features, a plurality of service provider features, and a model. The model can be a machine learning model that is trained using user features and service provider features. The central server computer 104 can then determine a plurality of carts using the plurality of user features, the plurality of service provider features, and the model. For example, the central server computer 104 can input the plurality of user features and the plurality of service provider features into the model. The model can then output the plurality of carts. The central server computer 104 can sort each cart of the plurality of carts in a particular order (e.g., using relevance scores output by the model). After the plurality of carts are ordered (e.g., sorted), the central server computer 104 can provide one or more carts of the plurality of carts to the end user device 102. In some embodiments, the central server computer 104 can provide each cart of the plurality of carts to the end user device 102.

The fulfillment request database 106 can store data related to previous (e.g., historical) fulfillment requests. For example, after a fulfillment request is fulfilled, the central server computer 104 can store fulfillment request data in the fulfillment request database 106. For example, the central server computer 104 can store any spatial-temporal fulfillment data (e.g., transporter user device location over time, transporter user device motion data over time, length of time taken to fulfil the fulfillment request, a fulfillment time, a fulfillment location, etc.), fulfillment service data (e.g., fulfilled services, an amount, a service provider computer identifier, an end user device identifier, a transporter user device identifier, etc.), and any other data relating to the fulfillment request and/or the fulfillment of the fulfillment request.

The one or more service provider computers 110 include computers operated by service providers. For example, a service provider computer can be a food provider computer that is operated by a food provider. The one or more service provider computers 110 can offer to provide services to the end users of the one or more end user devices 102. The service provider computer 110 can receive requests to prepare one or more items for delivery from the central server computer 104. The service provider computer 110 can initiate the preparation of the one or more items that are to be delivered to the end user of the end user device 102 by a transporter of a transporter user device 114.

The one or more transporter user devices 114 can be devices operated by transporters. The one or more transporter user devices 114 can be smartphones, wearable devices, personal assistant devices, etc. A transporter can request to fulfil an end user's fulfillment request. For example, the transporter user device 114 can generate and transmit a request to fulfil a particular end user's fulfillment request to the central server computer 104. The central server computer 104 can notify the transporter user device 114 of the fulfillment request. The transporter user device 114 can respond to the central server computer 104 with a request to perform the delivery to the end user as indicated by the fulfillment request.

The navigation network 116 can provide navigational directions to the one or more transporter user devices 114. For example, the transporter user device 114 can obtain a location from the central server computer 104. The location can be a service provider parking location, a service provider location, an end user parking location, an end user location, etc. The navigation network 116 can provide navigational data to the location. For example, the navigation network 116 can be a global positioning system that provides location data to the transporter user device 114.

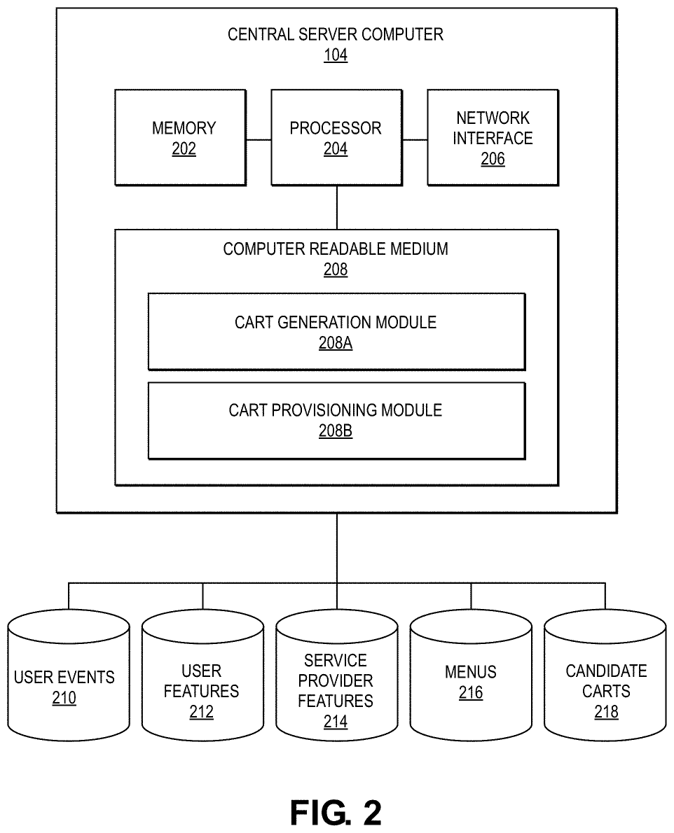

FIG. 2 shows a block diagram of a central server computer 104 according to embodiments. The exemplary central server computer 104 may comprise a processor 204. The processor 204 may be coupled to a memory 202, a network interface 206, and a computer readable medium 208. The computer readable medium 208 can comprise one or more modules. For example, the computer readable medium 208 can include a cart generation module 208A and a cart provisioning module 208B.

In some embodiments, the central server computer 104 may be in operative communication with one or more databases. For example, the central server computer 104 can be in operative communication with a user events database 210, a user features database 212, a service provider features database 214, a menus database 216, and a candidate carts database 218.

The memory 202 can be used to store data and code. For example, the memory 202 can store generated carts, user features, service provider features, a model, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: obtaining, by a server computer, a plurality of user features, a plurality of service provider features, and a model; inputting, by the server computer, the plurality of user features and the plurality of service provider features into the model; updating, by the server computer, the model to form an updated model; determining, by the server computer, a plurality of carts using the updated model, wherein each cart of the plurality of carts includes one or more items; providing, by the server computer, one or more carts of the plurality of carts to an end user device; receiving, by the server computer, a selection of a cart of the one or more carts or a modification thereof; processing, by the server computer, the selection by facilitating preparation and delivery of the one or more items in the cart; and updating, by the server computer, the updated model using data related to the cart to form a subsequent model.

The cart generation module 208A can comprise code or software executable by the processor 204, for generating carts. The cart generation module 208A, in conjunction with the processor 204, can generate a plurality of carts using a model. The model can be a machine learning model (e.g., a convolutional neural network, a recurrent neural network, a long short-term memory model, a hybrid model, etc.). The cart generation module 208A, in conjunction with the processor 204, can obtain a plurality of user features from a user feature database and can obtain a plurality of service provider features from a service provider feature database. The cart generation module 208A, in conjunction with the processor 204, can generate the plurality of carts by inputting user features and service provider features into the model. The model can output one or more carts. Each cart can include one or more items and can be associated with a service provider.

The cart generation module 208A, in conjunction with the processor 204, can update the model to form an updated model using the plurality of user features and the plurality of service provider features. Updating the model can include training the model. The cart generation module 208A, in conjunction with the processor 204, can update the model by iteratively adjusting numerical values in the model (e.g., biases, weights, etc.), such that the model more accurately outputs carts representative of real carts ordered by an end user when user features representing the end user and service provider features representing the service provider are input into the model.

The cart generation module 208A, in conjunction with the processor 204, can select an end user for which to generate the plurality of carts. The cart generation module 208A, in conjunction with the processor 204, can iterate through each service provider to generate the plurality of carts. As such, the cart generation module 208A, in conjunction with the processor 204, can generate one or more carts for each service provider for selected end user.

The cart generation module 208A, in conjunction with the processor 204, can input user features for the selected end user and service provider features for a first service provider of the plurality of service provider features into the updated model. The cart generation module 208A, in conjunction with the processor 204, can run the model at least once for each service provider. The cart generation module 208A, in conjunction with the processor 204, can determine the plurality of carts using the updated model.

The cart provisioning module 208B can comprise code or software executable by the processor 204, for providing carts to end user devices. The cart provisioning module 208B, in conjunction with the processor 204, can provide one or more carts from a cart database to end user devices. The cart provisioning module 208B, in conjunction with the processor 204, can provide carts to end user devices on a predetermined schedule, upon request, upon a central server computer application being opened on the end user device, and/or at any time.

For example, the cart provisioning module 208B, in conjunction with the processor 204, can receive a cart request message from an end user device. The cart request message can request one or more carts. The cart provisioning module 208B, in conjunction with the processor 204, can obtain one or more carts that are stored in association with data that identifies the end user device (e.g., an end user device identifier, an end user device public key, etc.). The cart provisioning module 208B, in conjunction with the processor 204, can then provide the one or more carts to the end user device in response to the cart request message.

The network interface 206 may include an interface that can allow the central server computer 104 to communicate with external computers. The network interface 206 may enable the central server computer 104 to communicate data to and from another device (e.g., one or more end user devices, one or more service provider computers, one or more transporter user devices, a navigation network, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

In some embodiments, the central server computer 104 may be in operative communication with the user events database 210, the user features database 212, the service provider features database 214, the menus database 216, and the candidate carts database 218. Each of the aforementioned databases can include any suitable databases. The databases may be conventional, fault tolerant, relational, scalable, secure databases such as those commercially available from Oracle™ or Sybase™.

The user events database 210 can store user event data. User event data can include data relating to end user actions (e.g., clicks, time spent on a page, time spent in the application, time spent during this session, etc.).

The user features database 212 can store user features. The user features can include order history, delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the user.

The service provider features database 214 can store service provider features. The service provider features can include service provider details, cuisine, ratings, food category, service provider location(s), item production time, promoted items, item cost, and/or other data representative of the service provider and/or items provided by the service provider.

The menus database 216 can store menus and other data relating to items provided by service providers. For example, the menus database 216 can include up-to-date menus provided by the service providers. A menu can include one or more items provided by the service provider (e.g., food items). The menu can also include one or more ingredients, dietary restrictions, a cost, and/or a production time for each item on the menu.

The candidate carts database 218 can store generated carts. The candidate carts database 218 can store a plurality of carts for a plurality of end users.

For example, the candidate carts database 218 can store carts for four end users. The candidate carts database 218 can store a plurality of carts for each of the four end users. The plurality of carts stored for each end user can be a queue of carts. The plurality of carts stored for each end user can be provided from the candidate carts database 218 to and end user device associated with the end user by the central server computer 104.

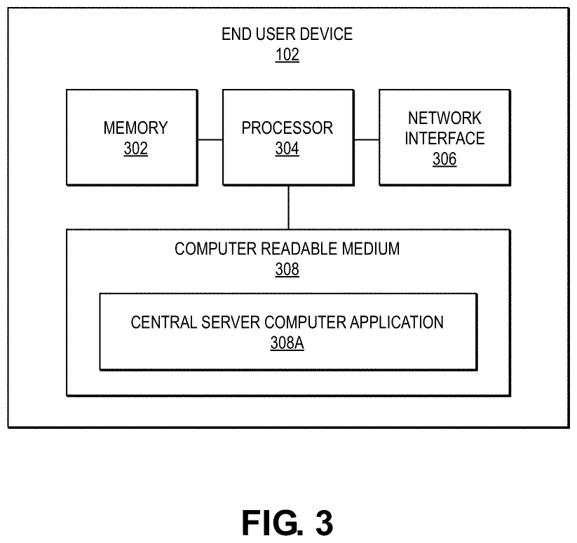

FIG. 3 shows a block diagram of an end user device 102 according to embodiments. The exemplary the end user device 102 may comprise a processor 304. The processor 304 may be coupled to a memory 302, a network interface 306, and a computer readable medium 308. The computer readable medium 308 can comprise a one or more modules. For example, the computer readable medium 308 can include a central server computer application 308A.

The memory 302 can be used to store data and code. For example, the memory 252 can store generated carts, user preferences, etc. The memory 302 may be coupled to the processor 304 internally or externally (e.g., cloud based data storage), and may comprise any combination of volatile and/or non-volatile memory, such as RAM, DRAM, ROM, flash, or any other suitable memory device.

The computer readable medium 308 may comprise code, executable by the processor 304, for performing method comprising: providing one or more user features to a server computer, wherein the server computer inputs the one or more user features, a plurality of additional user features and a plurality of service provider features into a model, updates the model to form an updated model, and determines a plurality of carts using the updated model, wherein each cart of the plurality of carts includes one or more items; receiving one or more carts of the plurality of carts from the server computer; obtaining a selection of a cart of the one or more carts or a modification thereof; and providing the selection of the cart to the server computer, wherein the server computer processes the selection by facilitating preparation and delivery of the one or more items in the cart and updates the updated model using data related to the cart to form a subsequent model.

The central server computer application 308A can comprise code or software executable by the processor 304, for interacting with a central server computer to obtain items from service providers as delivered by transporters. The central server computer application 308A, in conjunction with the processor 304, can allow the end user device 102 to communicate with the central server computer.

The central server computer application 308A, in conjunction with the processor 304, can request carts from the central server computer. For example, the central server computer application 308A, in conjunction with the processor 304, can generate a cart request message that requests one or more carts. The central server computer application 308A, in conjunction with the processor 304, can provide the cart request message to the central server computer. The central server computer application 308A, in conjunction with the processor 304, can receive one or more carts from the central server computer in response to the cart request message.

The central server computer application 308A, in conjunction with the processor 304, can receive input from an end user to select a cart. The central server computer application 308A, in conjunction with the processor 304, can check out with the cart to obtain the one or more items in the cart from the service provider. The central server computer application 308A, in conjunction with the processor 304, can generate a fulfillment request message that indicates the selected items and the selected service provider. The fulfillment request message can also include an end user device location and/or any other end user features.

The network interface 306 can be similar to the network interface 206 and will not be repeated here.

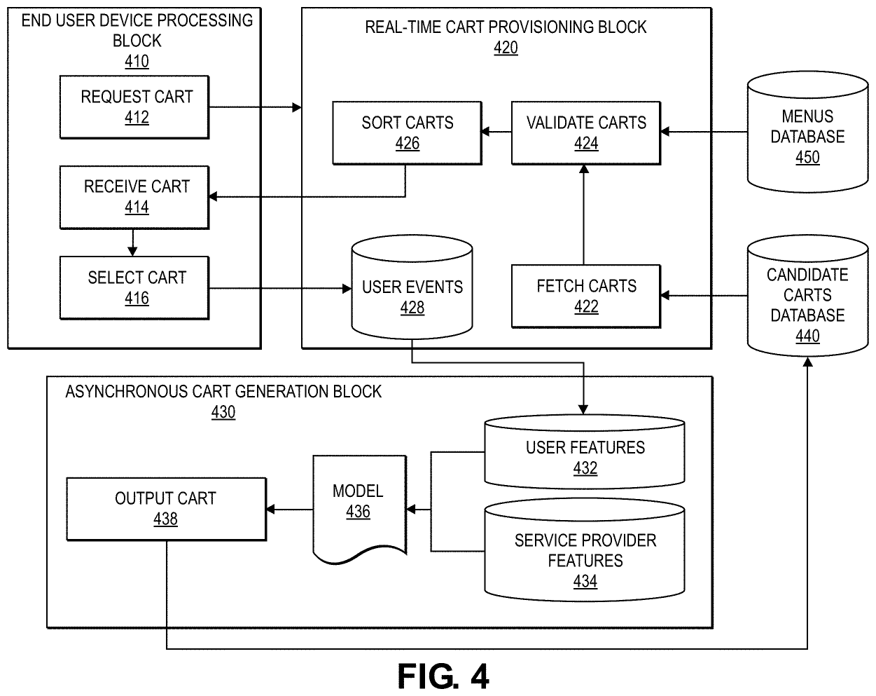

FIG. 4 shows a hybrid diagram illustrating a cart generation method according to embodiments. The method illustrated in FIG. 4 will be described in the context of a client device, which is an end user device, requesting one or more carts upon opening a food delivery application. It is understood, however, that the invention can be applied to other circumstances (e.g., pushing one or more carts to the client device, etc.). In some embodiments, the cart generation method illustrated in FIG. 4 can be utilized in a marketplace, a digital food court, a storefront, batched orders, an advertisement or promotion, a hyper local pickup order, and/or in recurring order/subscription service offerings. The cart generation method can also be used in general shopping applications, such as online shopping contexts or retail contexts with digital kiosks.

FIG. 4 will be described in the context of three main processing blocks including end user device processing block 410, real-time cart provisioning block 420, and asynchronous cart generation block 430. The end user device processing block 410 can include steps performed by the end user device 102. The real-time cart provisioning block 420 and the asynchronous cart generation block 430 can include steps performed by the central server computer 104.

At step 412, in the end user device processing block 410, an end user device, can generate and provide a cart request message requesting one or more carts to a central server computer. The end user device can generate the cart request message when a central server computer application is opened by the end user, or when the end user interacts with it.

In the real-time cart provisioning block 420, after receiving the cart request message, the central server computer can perform real-time cart provisioning. For example, the central server computer can obtain one or more carts to provide to the end user device. In some embodiments, the central server computer can provide the one or more carts to the end user device in response to the cart request message. In other embodiments, the central server computer can push the one or more carts to the end user device when the end user device is online. The real-time cart provisioning block 420 includes steps 422, 424, 426, and 428.

At step 422, the central server computer can obtain one or more carts from a candidate carts database 440. In some embodiments, the central server computer can obtain a predetermined number of carts from the candidate carts database 440. In other embodiments, the central server computer can obtain a requested number of carts from the candidate carts database 440, as indicated by the cart request message. In some embodiments, each cart in the candidate carts database 440 can be stored in association with a relevance score determined by the asynchronous cart generation block 430, which indicates how relevant the cart is to the end user. As an example, the central server computer can obtain five carts from the candidate carts database 440 along with five relevance scores.

The carts obtained from the candidate carts database 440 can be generated in the asynchronous cart generation block 430, described in further detail below.

At step 424, after obtaining the one or more carts, the central server computer can validate the one or more carts. For example, the central server computer can determine whether or not the one or more carts are still relevant to the end user of the end user device. In some embodiments, the central server computer can validate the one or more carts using a menus database 450. For example, the central server computer can determine whether or not the items included in each of the one or more carts is still available from the service provider by checking a menu stored in the menus database 440 that is associated with the service provider that provides the items. If the items are no longer available, or are not available at a particular time of day or day of the week, the central server computer can remove the no longer valid cart from the one or more carts.

As an example, the central server computer can validate the five carts obtained from the candidate carts database 440. The central server computer can determine that each cart is valid except for the third cart in the list of five carts. The third cart, for example, may be a cart that includes dinner foods that are only provided after 4 PM by the service provider, but the current time of day may be 8:00 AM. The central server computer can determine that the third cart includes items that are not currently available.

At step 426, in some embodiments, after validating the one or more carts, the central server computer can sort the one or more carts. The central server computer can sort the one or more carts based on a relevance score indicating the cart's relevance to the user of the end user device. The central server computer can utilize the relevance scores obtained from the candidate carts database 440. The central server computer can sort the one or more carts in an order such that the end user is provided with the most relevant cart first.

In some embodiments, the central server computer can determine a relevance score for each cart of the one or more carts if the relevance score does not yet exist. The central server computer can determine the relevance score based on one or more user events. The central server computer can retrieve the user events from a user events database 418. The central server computer can generate a relevance score in any suitable manner. For example, the central server computer can generate a relevance score using a ranking process, a machine learning process, and/or other score determination method. For example, in some embodiments, the carts sorting process can be implemented with a weighted sort method that factors in service provider utilization, user events, and promotions data, and/or could utilize a machine learning model such as word2vec to obtain embeddings of the above and cosine similarity to get a relevance score between 0-1.

The central server computer can provide the sorted carts to the end user device after receiving a cart request message from the end user device. For example, the sorted carts can be provided to the end user device in response to the cart request message received at step 412. For example, the central server computer can store the remaining four carts (after removing one cart during validation) and provide the four carts in a queue to the end user device. The queue itself can be a data structure such as a queue, a priority queue, a stack, an array, or other data item that can indicate the order of the carts.

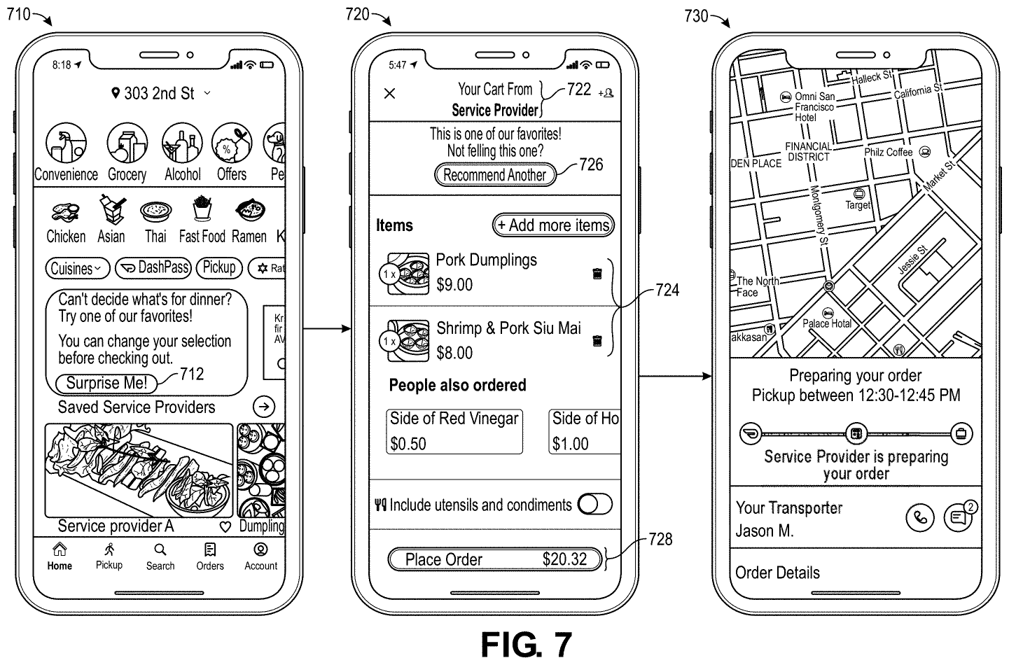

At step 414 of the end user device processing block 410, the end user device can receive the sorted carts from the central server computer. A first cart of the sorted carts can be presented to the end user on the end user device (e.g., as described in references to FIGS. 7-9).

At step 416, the end user device can receive a selection of a cart from the end user. The end user can make a selection to check out with a particular cart. The end user device can proceed to perform a transaction to obtain the one or more items in the cart from the service provider. For instance, during or after checking out, the end user device can provide a fulfillment request message to the central server computer.

The fulfillment request message can include the one or more items from the selected cart and can also indicate the service provider that provides the one or more items. The fulfillment request message can also include communication data that allows the end user device and the central server computer to identify with which computer to communicate (e.g., end user device identifiers, central server computer identifiers, communication channel identifiers, etc.). The fulfillment request message can also include location data (e.g., a location of the end user device or other selected delivery location, the service provider location, etc.).

At step 428, after receiving the fulfillment request message from the end user device, the central server computer can store user features obtained and/or derived from the fulfillment request message into a user features database. For example, the central server computer can generate a user feature that indicates that the end user device ordered a particular cuisine as indicated by the one or more items in the cart. The central server computer can determine any user feature that includes information regarding the end user. The central server computer can also update currently stored user features based on the fulfillment request message. The user features can include a delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the end user. The central server computer can also store the cart that was used by the end user in the current transaction. The cart can be a “previous cart” with respect to training a machine learning model and for future cart generation processes.

In the asynchronous cart generation block 430, the central server computer can perform an asynchronous cart generation process. The asynchronous cart generation process can be an asynchronous machine learning based cart generation process. The generation of carts can be performed asynchronously from providing carts to the end user device (e.g., in response to a cart request message). The asynchronous cart generation block 430 can include steps 432, 434, 436, and 438.

At step 432, the central server computer can obtain a plurality of user features from a user features database. The central server computer can obtain newly added user features from the user features database (e.g., added during step 428). The newly added user features can be utilized to train the model. The central server computer can also obtain user features of a particular end user to generate a cart for that end user.

At step 434, the central server computer can obtain a plurality of service provider features from a service provider features database. The central server computer can obtain service provider features for the service provider(s) that provided the items in the previous cart. The service provider features can include cuisine, ratings, food category, service provider location(s), item production time, promoted items, item cost, and/or other data representative of the service provider and/or items provided by the service provider.

In some embodiments, the central server computer can obtain a model from a model database. The model can be a convolutional neural network (CNN), a recurrent neural network (RNN), a long short-term memory (LSTM) model or a hybrid model handling numeric and textual features separately. The model can be previously trained to generate carts based on user features and service provider features.

At step 436, after obtaining the plurality of user features and the plurality of service provider features, the central server computer can update the model and determine a cart.

The central server computer can update the model to form an updated model using the newly added user features and service provider features corresponding to the service provider of the previous cart. Updating the model can include training the model. The central server computer can train the model using newly user features, the service provider features corresponding to the service provider of the previous cart, and the previous cart. The central server computer can train the model using the features as inputs and using the model to try to generate a cart similar to the previous cart by iteratively adjusting values inside the model.

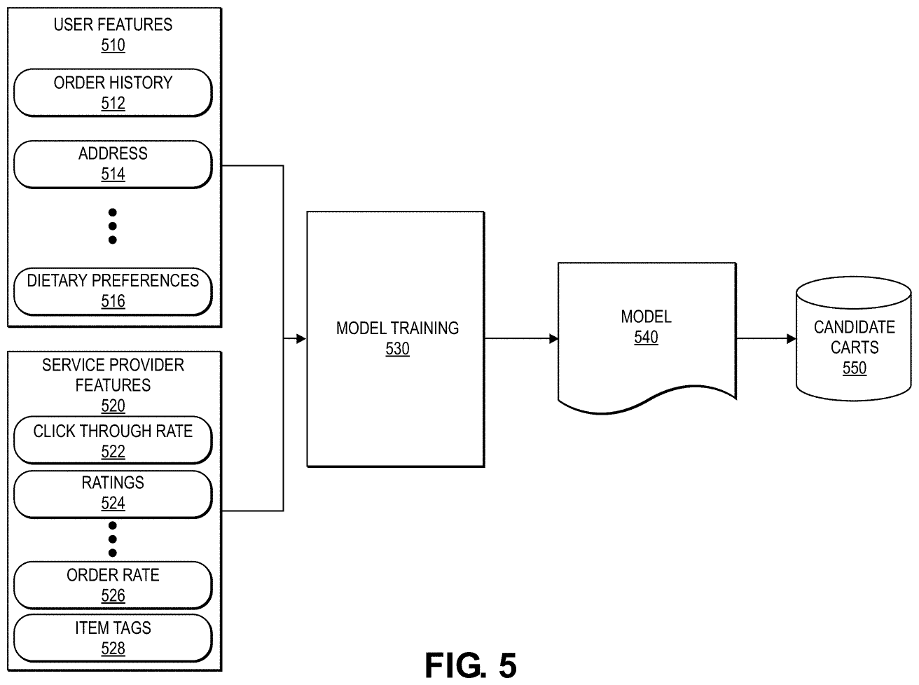

After updating the model, the central server computer can generate one or more carts including one or more items using the updated model. The central server computer can generate a cart for each service provider represented by the plurality of service provider features. The central server computer can generate a cart by inputting the user features for the user and service provider features for a first service provider into the model. The model can output a first cart including one or more items. The central server computer can then interactively generate a plurality of carts by inputting the user features for the user and service provider features for the subsequent service provider into the model. Model training and cart generation will be further described in reference to FIG. 5.

At step 438, the central server computer can output the one or more generated carts. The carts can indicate the selected service provider as well as one or more items provided by the service provider. After generating the carts, the central server computer can store the carts in the candidate carts database 440. The central server computer can perform step 420 any number of times to generate a plurality of carts to store in the candidate carts database 440. In some embodiments, the central server computer can also purge outdated carts and/or any duplicate carts. For example, carts that have been stored for more than 1 week can be purged in some embodiments.

In some embodiment, the central server computer can also update existing cart suggestions with higher scoring cart counterparts.

In some embodiments, the central server computer can provide one or more generated carts to the end user device for later user by the end user device. The one or more generated carts can be stored on the end user device until the end user selects to obtain a cart.

FIG. 5 shows a hybrid diagram illustrating a machine learning training and cart generation process according to embodiments. The method illustrated in FIG. 5 will be described in the context of a central server computer training a machine learning model and generating one or more carts, where each cart includes one or more items.

The central server computer can train a machine learning model that can determine candidate carts based on input user features and service provider features.

The central server computer can obtain user features 510. The central server computer can obtain the user features 510 from a user features database. The user features can include an order history 512, an address 514, and dietary preferences 516. The user features can further include any features that can represent the user.

The central server computer can also obtain service provider features 520. The central server computer can obtain the service provider features 520 from a service provider features database. The service provider features 520 can include a click through rate 522, ratings 524, an order rate 526, and item tags 528. The service provider features can further include any features that can represent the service provider or items provided by the service provider. In some embodiments, the central server computer can filter the service provider features 520 to include service provider features for a subset of service providers. For example, the central server computer can filter the service provider features 520 to include service provider features of the most popular service providers, the top rated service providers, a random selection of service providers, or other filtering criteria. Selecting a smaller subset of candidate service providers can aid in focusing the machine learning process, and can filter service providers based on a variety of factors such as popularity, service providers promotions, and geo location.

After obtaining the user features 510 and the service provider features 520, the central server computer can perform model training 530. Model training 530 can include a machine learning process. Model training 530 can accept the user features 510 and the service provider features 520 as input. For example, model training 530 can include training a CNN, an RNN, a LSTM model or a hybrid model that manages numeric and textual features separately.

The model can be trained during model training 530 in any manner using the user features 510 and the service provider features 520 to output one or more carts. In some embodiments, the training dataset can include sample output data (e.g., sample carts) and the corresponding sets of input data that have an influence on the output. The central server computer can train the model to generate carts that are relevant to users based on user features and service provider features.

The model can be a neural network. A neural network can include a number of nodes (e.g., neurons) that perform operations on input data. The nodes can be structured into different layers, including an input layer, one or more hidden layers, and an output layer. Each node in the neural network computes an output value by applying a specific function to the input values received from the receptive field in the previous layer. The function that is applied to the input values is determined by a vector of weights and a bias. Learning consists of iteratively adjusting these biases and weights. The vector of weights and the bias can be referred to as filters and represent particular features of the input (e.g., a particular shape).

Training the model can include adjusting the biases and weights such that when provided a training input and a training output, the model accepts the training input and generates an output that is similar to the training output.

After training the model during model training 530, the central server computer can output the model 540. The model 540 can be a machine learning model and can be stored in a model database.

The model 540 can be utilized by the central server computer to determine one or more candidate carts in the candidate carts database 550. For example, input data (e.g., user features and service provider features) can be input into the model 540 to output one or more cart.

The plurality of user features can include user features for a particular end user (e.g., the end user for which this cart is being generated). The plurality of service provider features can include user features from one or more service providers. To generate a cart, the central server computer can input the plurality of user features and service provider features from a single service provider of the plurality of service provider features to generate a cart that includes items from that service provider. The central server computer can input service provider features from each service provider including into the plurality of service provider features to generate a plurality of carts from different service provider computers for the end user.

The central server computer can also generate a relevance score. The relevance score can be generated by the model or a different scoring process. The central server computer can generate a relevance score using a ranking process, a machine learning process, and/or other score determination method. For example, in some embodiments, the carts scoring process can be implemented with a weighted sort method that factors in service provider utilization, user events, and promotions data, and/or could utilize a machine learning model such as word2vec to obtain embeddings of the carts and a cosine similarity value to get a relevance score between 0-1.

The central server computer can sort the carts into a queue based on the relevance score. The central server computer can place carts that are most relevant to the end user at the beginning of the queue.

The central server computer can store the generated carts into a candidate carts database 550. The carts can be stored in association with data that identifies the end user and/or the end user device (e.g., a username, an end user device public key, etc.). Each cart can also be stored in association with a relevance score. The carts can later be provided to an end user device.

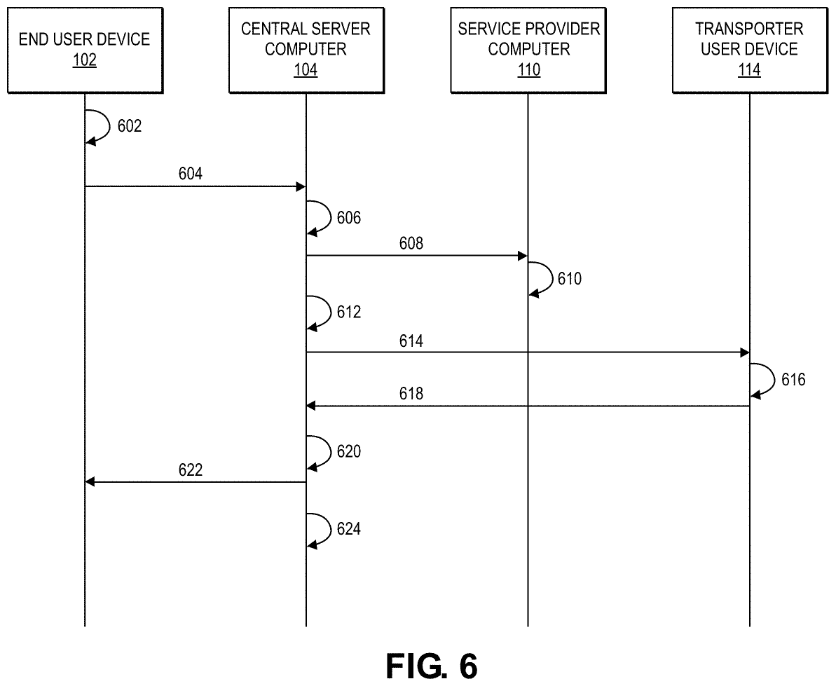

FIG. 6 shows a flow diagram illustrating a preparation and delivery method according to embodiments. The method illustrated in FIG. 6 will be described in the context of the central server computer 104 receiving a fulfillment request message from the end user device 102 to fulfil preparation and delivery of one or more items from a cart to the end user of the end user device 102. The central server computer 104 can communicate with the service provider computer 110 and the transporter user device 114 to fulfil the fulfillment request.

At step 602, the end user device 102 can decide to check out with a cart in a central server computer application installed on the end user device 102. The cart can include one or more items that are provided from a service provider of the service provider computer 110.

At step 604, after checking out with the cart, the end user device 102 can provide a fulfillment request message including the one or more items from the cart to the central server computer 104. The fulfillment request message can also include a service provider computer identifier that identifies the service provider computer 110.

At step 606, after receiving the fulfillment request message, the central server computer 104 can perform a transaction process with the end user device 102. For example, the central server computer 104 can communicate with a payment network to process the transaction for the one or more items. The central server computer 104 can receive an indication of whether or not the transaction is authorized. If the transaction is authorized, then the central server computer 104 can proceed with step 608.

At step 608, the central server computer 104 can provide the fulfillment request message, or a derivation thereof, to the service provider computer 110. The central server computer 104 can determine which service provider computer of a plurality of service provider computers to communicate with based on the service provider indicated in the fulfillment request message. For example, the fulfillment request message can indicate that the one or more items are provided by the service provider of the service provider computer 110. The central server computer 104 can identifying the service provider computer 110 using the service provider computer identifier in the fulfillment request message.

At step 610, after receiving the fulfillment request message, the service provider computer 110 can initiate preparation of the one or more items. For example, the service provider computer 110 can alert service providers of the fulfillment request message at the service provider location of the service provider computer 110. The service providers can prepare the one or more items for pick up by a transporter.

At step 612, after providing the fulfillment request message to the service provider computer 110, the central server computer 104 can determine one or more transporter user devices that are capable of fulfilling the fulfillment request message. The central server computer 104 can determine the one or more transporter user devices from a plurality of transporter user devices. The central server computer 104 can determine the one or more transporter user devices based on whether or not the transporter user device is online, whether or not the transporter user device is already fulfilling a different fulfillment request message, a location of the transporter user device, etc.

At step 614, after determining the one or more transporter user devices, the central server computer 104 can provide the fulfillment request message, or a derivation thereof, to the one or more transporter user devices including the transporter user device 114.

At step 616, after receiving the fulfillment request message, the transporter of the transporter user device 114 can determine whether or not they want to perform the fulfillment. The transporter can decide that they want to perform the delivery of the one or more items from the service provider location to the end user location. The transporter user device 114 can generate an acceptance message that indicates that the fulfillment request is accepted.

At step 618, after generating the acceptance message, the transporter user device 114 can provide the acceptance message to the central server computer 104.

After providing the acceptance message to the central server computer 104, the transporter user device 114 can communicate with the navigation network 116 to proceed to the service provider location for the transporter to obtain the one or more items. The transporter user device 114 can receive input from the transporter that indicates that the transporter obtained the one or more items (e.g., the transporter selects that they picked up the items). The transporter user device 114 can then communicate with the navigation network 116 to proceed to the end user location to provide the one or more items to the end user. In some embodiments, the transporter user device 114 can provide update messages to the central server computer 104 that include a transporter user device 114 location and/or event data (e.g., items picked up, items delivered, etc.).

In some embodiments, after receiving the acceptance message, the central server computer 104 can notify the other transporter user devices that received the fulfillment request message that the fulfillment request is no longer available.

At step 620, at any point after receiving the acceptance message, the central server computer 104 can check the status of the fulfillment request. For example, the central server computer 104 can determine the location of the transporter user device 114 and can determine an estimated amount of time for the transporter user device 114 to arrive at the end user location.

At step 622, the central server computer 104 can provide an update message to the end user device 102 that includes data related to the fulfillment of the fulfillment request message. The data can include an estimated amount of time, the transporter user device location, event data (e.g., items picked up from the service provider), and/or other data related to the fulfillment of the fulfillment request message.

At step 624, the central server computer 104 can store any data received, sent, and/or processed during the fulfillment of the fulfillment request message into to database. For example, the central server computer 104 can store user's cart selection as user features into a user feature database.

FIG. 7 shows a user interface diagram illustrating a cart suggestion process according to embodiments. The user interface illustrated in FIG. 7 shows a first user interface 710, a second user interface 720, and a third user interface 730 that can be presented to an end user on an end user device (e.g., a smartphone). The user interfaces illustrated in FIG. 7 illustrate an end user selecting to receive a cart generated by the central server computer. The cart includes both a suggested service provider and suggested items. The end user can select to checkout with the cart and obtain the items included in the cart.

The first user interface 710 illustrates a start screen on central server computer application that can present various ordering options to the end user. For example, the first user interface 710 can present a button 712 (or other interactive UI element) to the end user. The button 712, when selected, can initiate obtaining a generated cart to present to the end user. For example, the button 712, when selected, can initiate obtaining a pre-stored cart that was previously generated using FIG. 4 and stored on the end user device. The cart can be a first cart of a queue of carts. When the button 712 is selected, the second user interface 720 can be displayed on the end user device.

The second user interface 720 illustrates a generated cart available to the end user. The cart indicates a service provider name 722 and items 724 to be provided by the service provider. The second user interface 720 can allow the end user to add items and remove items from the cart using appropriate elements on the second user interface 720. The second user interface 720 can further include a new cart generation button 726 that, when selected, can initiate obtaining another generated cart to present to the end user. The new cart generation button 726 can initiate obtaining a next cart (e.g., a second cart) of the sorted plurality of carts. The second user interface 720 can also include a place order button 728. The place order button 728 can initiate placing the order for the current cart presented by the second user interface 720. Once the place order button 728 is selected, the third user interface 730 can be displayed on the end user device.

The third user interface 730 illustrates an order confirmation screen that can present details regarding the order selected via the second user interface 720 to the end user. The third user interface 730 can display service provider information (e.g., a name, a location, etc.), transporter information (e.g., a name, a location, etc.), and order information (e.g., items ordered, a pickup time, a delivery time, etc.).

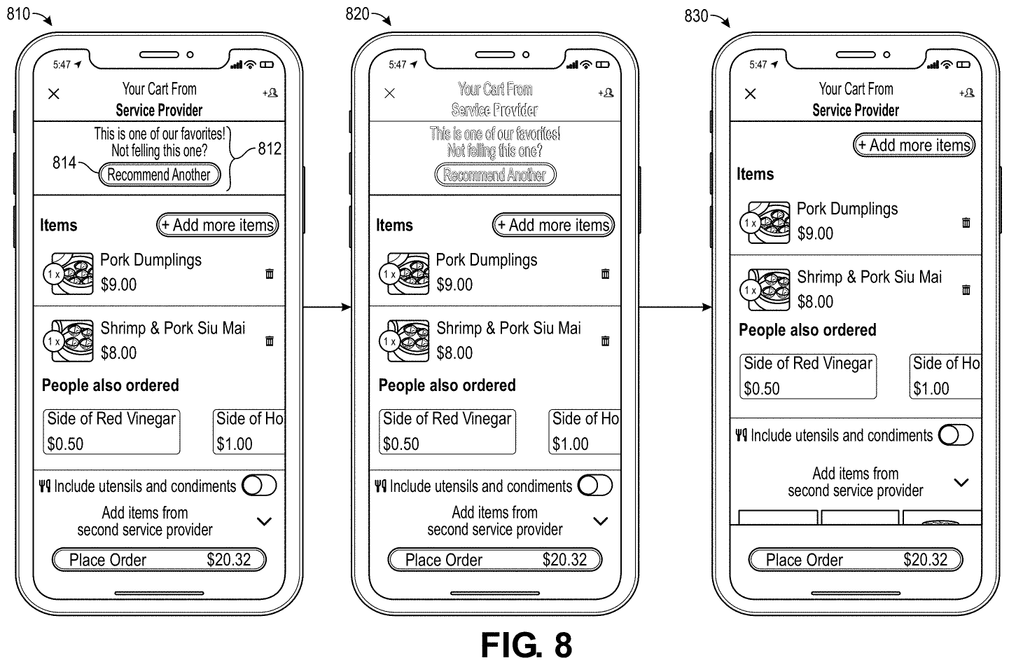

FIG. 8 shows a user interface diagram illustrating a generated cart according to embodiments. The user interface illustrated in FIG. 8 shows a first user interface 810, a second user interface 820, and a third user interface 830 that can be presented to an end user on an end user device. The user interfaces included illustrated in FIG. 8 illustrate a process relating to a user deciding to check out with a generated cart received from a central server computer.

The first user interface 810 illustrates a cart available to the end user. The first user interface 810 can be the same user interface presenting the cart as the second user interface 720 of FIG. 7. The first user interface 810 includes a banner 812 that includes a new cart generation button 814. The new cart generation button 814 can be the same as the new cart generation button 726 of FIG. 7.

When the end user interacts with the first user interface 810, the banner 812 can be hidden. For example, when the end user adds an item to the cart, removes an item from the cart, scrolls through the cart, clicks (or otherwise selects) a UI element in the displayed cart, the first user interface 810 can transition to the second user interface 820 and then to the third user interface 830. The banner 812 in the first user interface 810 can become grayed out, fade away, etc. when the end user interacts with the cart, as illustrated in the second user interface 820.

The third user interface 830 illustrates the cart without the banner 812. The cart illustrated in the third user interface 830 can function as a regular cart (e.g., operate the same as a cart created by the end user). As shown, there is a button for allowing a user to add or remove items from the illustrated cart.

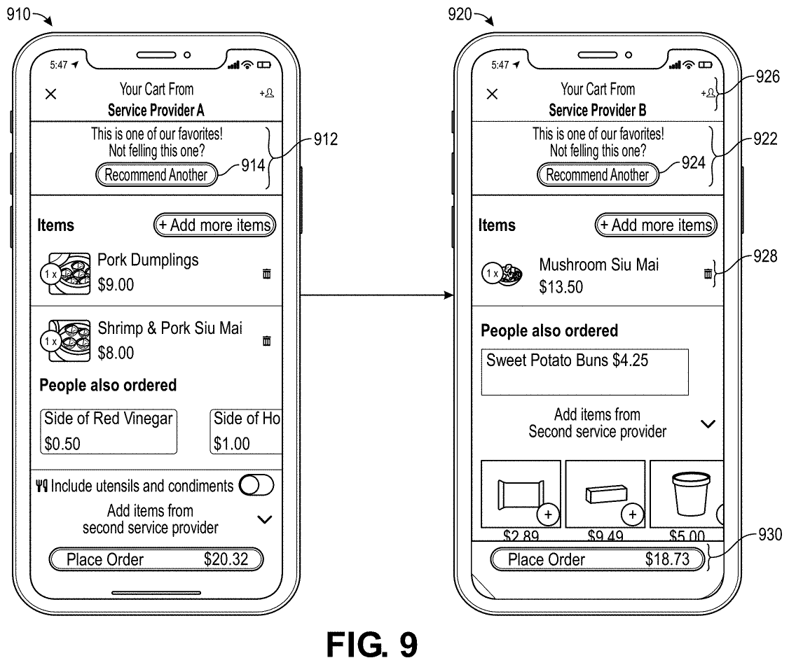

FIG. 9 shows a user interface diagram illustrating multiple generated carts according to embodiments. The user interface illustrated in FIG. 9 shows a first user interface 910 and a second user interface 920 that can be presented to an end user on an end user device. The user interfaces illustrated in FIG. 9 describe a method where an end user can select to obtain multiple different carts generated by a central server computer.

The first user interface 910 illustrates a generated cart available to the end user. The first user interface 910 can be the same user interface presenting the cart as the second user interface 720 of FIG. 7 and the first user interface 810 of FIG. 8. The first user interface 910 includes a banner 912 that includes a new cart generation button 914. The banner 912 and the new cart generation button 914 can respectively be the same as the banner 812 and the new cart generation button 814 of FIG. 8.

When the end user interacts with the new cart generation button 914, a new cart (e.g., a next cart in a queue of generated carts) can be obtained and presented to the user. For example, the end user device can transition from the first user interface 910 to the second user interface 920.

The second user interface 920 illustrates a second cart available to the end user. The second user interface 920 includes a banner 922 and a new cart generation button 924. When selected, the new cart generation button 924 can initiate obtaining a generated cart to present to the end user. The new cart generation button 924 can initiate obtaining a next cart (e.g., a third cart) of the queue of carts. The second user interface 920 also includes a service provider name 926 and items 928 to be provided by the service provider. The second user interface 920 can allow the end user to add items and remove items from the cart. The second user interface 920 can also include a place order button 930. The place order button 930 can initiate placing the order for the current cart presented by the second user interface 920.

In some embodiments, additional user interface elements can be presented to the end user. For example, the end user can be presented with a button that allows the end user to compare one or more carts (e.g., compare the first cart and the second cart in the queue of carts). In other embodiments, the end user can be presented with a button the allows the end user to see and navigate to one or more previous cart suggestions. In yet other embodiments, the end user can be presented with a button that allows the end user to shuffle items in a current cart, while keeping the same service provider. For example, shuffling the items can include replacing a current item with a next suggested item, replacing a current item with a random item, removing a current item, etc.

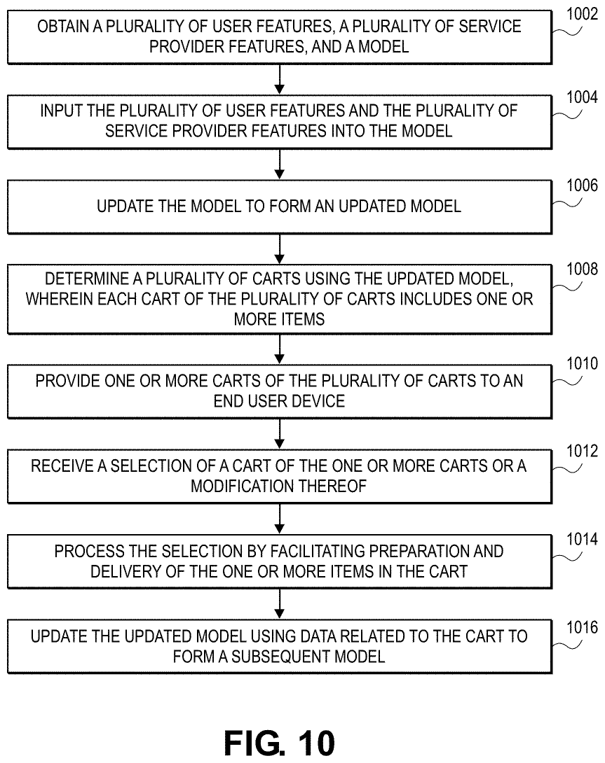

FIG. 10 shows a flow diagram illustrating a cart generation and provisioning method according to embodiments. As an example, FIG. 10 will be described in the context of an end user selecting to check out with a generated cart that was generated by a central server computer.

At step 1002, a server computer can obtain a plurality of user features, a plurality of service provider features, and a model. The server computer can obtain the plurality of user features from a user features database. The user features include order histories, addresses, and/or dietary preferences. The server computer can obtain the plurality of service provider features from a service provider features database. The service provider features include ratings, order rates, and/or item tags. The server computer can obtain the model from a model database. The model can be a machine learning model that is trained using user features and service provider features. The server computer can be a central server computer.

At step 1004, the server computer can input the plurality of user features and the plurality of service provider features into the model.

At step 1006, the server computer can update the model to form an updated model. For example, the server computer can further train the model using user features and service provider features to update the model.

At step 1008, after updating the model, the server computer can determine a plurality of carts using the updated model. Each cart of the plurality of carts includes one or more items.

The server computer can store the plurality of carts in a candidate cart database. The plurality of carts can remain in the candidate cart database until the server computer provides one or more carts to an end user device or until the end user device requests one or more carts. For example, the server computer can receive a cart request message from the end user device requesting one or more carts.

In some embodiments, after determining the plurality of carts, the server computer can sort each cart of the plurality of carts based on a relevance score that indicates how relevant each cart is to an end user of the end user device. The relevance score can be created by the updated model.

At step 1010, after determining the plurality of carts, the server computer can provide one or more carts of the plurality of carts to the end user device.

At step 1012, after providing the one or more carts to the end user device, the server computer can receive a selection of a cart of the one or more carts or a modification thereof. The modification thereof can be a modified cart created by the end user device based on one of the one or more carts.

At step 1014, after receiving the selection of the cart or the modification thereof, the server computer can process the selection by facilitating preparation and delivery of the one or more items in the cart.

The server computer can process the selection by generating an order request message comprising the one or more items. The order request message can be a request to prepare the one or more items for delivery to the end user of the end user device.

The server computer can provide the order request message to a service provider computer associated with the one or more items for preparation of the one or more items. The server computer can then determine a transporter user device of a plurality of transporter user devices based on a location of the transporter user device, an end user location, and a service provider location.

After determining a transporter user device that is located in a suitable location relative to the end user location and the service provider location, the server computer can generate a delivery request message including the end user location and the service provider location. The delivery request message can request that the transporter user device deliver the one or more items from the service provider location to the end user location. The server computer can provide the delivery request message to the transporter user device. A transporter operating the transporter user device can determine whether or not to accept to deliver the one or more items. The transporter user device can notify the server computer of whether or not the delivery is accepted in a delivery response message.

The server computer can receive the delivery response message indicating whether or not the transporter user device accepts to deliver the one or more items. If the delivery response message indicates that the transporter user device does not accept to deliver the one or more items, then the server computer can determine a secondary transporter user device and provide the delivery request message to the secondary transporter user device. If the delivery response message indicates that the transporter user device accepts the delivery, the server computer can proceed with processing the delivery.

For example, as the delivery progresses, the server computer can determine an updated location of the transporter user device. The server computer can generate an estimated length of time needed for the transporter user device to arrive at the end user device location. The server computer can notify the end user device of the updated location of the transporter device and/or the estimated length of time.

At step 1016, the server computer can update the updated model using data related to the cart to form a subsequent model. The data related to the cart can include user features and service provider features.

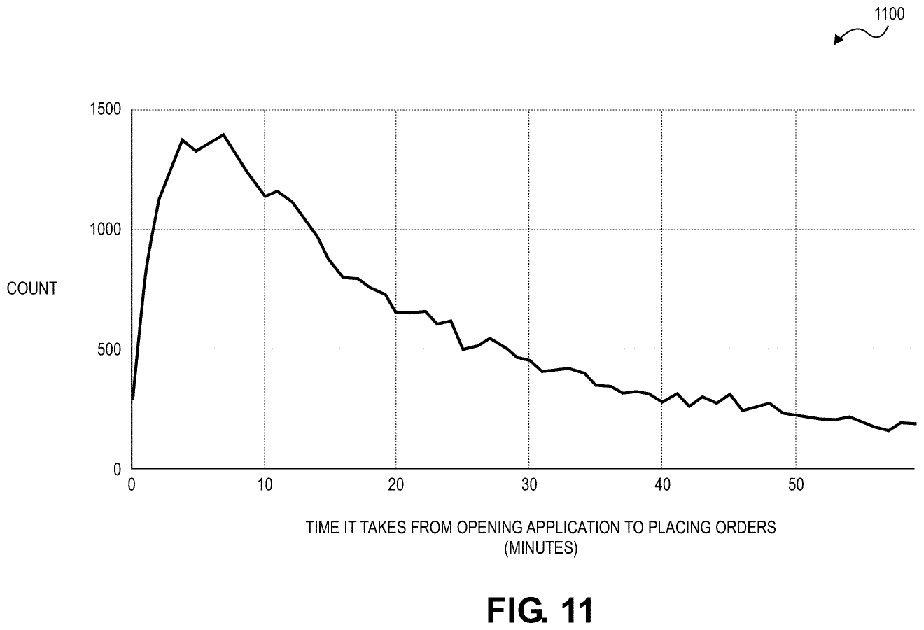

FIG. 11 shows a graph 1100 illustrating the length of time it takes to place an order according to embodiments. The graph 1100 shows the length of time end users take to place an order once the end user opens a central server computer application. The x-axis shows the length of time in minutes. The y-axis shows the number of instances of the length of time in the dataset.

The graph 1100 shows that many users take a large amount of time to navigate many service providers, select a service provider, navigate many items provided by the service provider, create a cart including selected items, and proceed to checkout with the cart. The average length of time for end users to perform this process is 19 minutes. Furthermore, approximately 26% of end user created carts are abandoned after creation. The length of time taken can be attributed to end user decision paralysis. Embodiments solve the problem of end users wasting time by creating a technical solution that streamlines the cart creation process.

Embodiments of the disclosure have a number of advantages. For example, embodiments reduce the number of inputs required from an end user when ordering items. For example, a user that creates a cart by selecting and deselecting items in the cart may interact with an end user device at least 5-10 times to fill a cart, whereas embodiments can present a filled cart to the end user to accept with a single user device interaction. This can reduce the amount of time spent by end users to make customized purchases and can make purchasing experiences more convenient for end users. Embodiments can also reduce the amount of power consumption and computing resource requirements since fewer interactions are needed between end user devices and the central server computer. If there are thousands or millions of end users, the power and computational resource savings can be significant.

Other embodiments of the disclosure provide for an additional technical solution to the technical problem of how to provide accurate order recommendations to an end user device that has limited computational power and limited storage capabilities. Embodiments solve the aforementioned technical problem by, in part, asynchronously generating a plurality of carts that include recommended items from recommended service providers. The central server computer can generate the carts regardless the current state of the end user device. For example, the central server computer can generate the carts prior to the end user device requesting and/or needing to present any carts to the end user. In some cases, the central server computer can cache the generated carts in a candidate cart database. In other cases, the central server computer can cache the generated carts directly on the end user device. Thus, the end user device can obtain carts on demand when the end user is attempting to order items. As noted above, fewer interactions are needed in embodiments as compared to conventional systems, and this can result in significant power and computational savings relative to conventional systems.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
obtaining, by a server computer, a plurality of user features, a plurality of service provider features, and a model;
inputting, by the server computer, the plurality of user features and the plurality of service provider features into the model;
updating, by the server computer, the model to form an updated model;
determining, by the server computer, a plurality of carts using the updated model, wherein each cart of the plurality of carts includes one or more items;
providing, by the server computer, one or more carts of the plurality of carts to an end user device;
receiving, by the server computer, a selection of a cart of the one or more carts or a modification thereof;
processing, by the server computer, the selection by facilitating preparation and delivery of the one or more items in the cart; and
updating, by the server computer, the updated model using data related to the cart to form a subsequent model.

2. The method of claim 1, wherein the model is a machine learning model that is trained using user features and service provider features.

The method of claim 1, wherein after determining the plurality of carts, the method further comprises:
sorting, by the server computer, each cart of the plurality of carts based on a relevance score that indicates how relevant each cart is to an end user of the end user device.

4. The method of claim 3, wherein the relevance score for each cart of the plurality of carts is created by the updated model.

5. The method of claim 1 further comprising:
storing, by the server computer, the plurality of carts in a candidate cart database.

6. The method of claim 1, wherein obtaining the plurality of user features, the plurality of service provider features, and the model further comprises:
obtaining, by the server computer, the plurality of user features from a user features database, wherein user features include order histories, addresses, and/or dietary preferences;
obtaining, by the server computer, the plurality of service provider features from a service provider features database, wherein the service provider features include ratings, order rates, and/or item tags; and
obtaining, by the server computer, the model from a model database.

7. The method of claim 1, wherein the modification thereof is a modified cart created by the end user device based on one of the one or more carts.

8. The method of claim 1 further comprising:
receiving, by the server computer, a cart request message from the end user device, wherein providing the one or more carts of the plurality of carts to the end user device is in response to the cart request message.

9. The method of claim 1, wherein the data related to the cart includes user features and service provider features.

10. The method of claim 1, wherein processing the selection by facilitating preparation and delivery of the one or more items in the cart further comprises:
generating, by the server computer, an order request message comprising the one or more items;
providing, by the server computer, the order request message to a service provider computer associated with the one or more items for preparation of the one or more items;
determining, by the server computer, a transporter user device of a plurality of transporter user devices based on a location of the transporter user device, an end user location, and a service provider location;
generating, by the server computer, a delivery request message including the end user location and the service provider location;
providing, by the server computer, the delivery request message to the transporter user device, wherein the transporter user device determines whether or not to accept to deliver the one or more items; and
receiving, by the server computer, a delivery response message indicating whether or not the transporter user device accepts to deliver the one or more items.

11. The method of claim 10 further comprising:
determining, by the server computer, an updated location of the transporter user device; and
notifying, by the server computer, the end user device of the updated location of the transporter user device.

12. A server computer comprising:
a processor; and
a computer-readable medium coupled to the processor, the computer-readable medium comprising code executable by the processor for implementing a method comprising:
obtaining a plurality of user features, a plurality of service provider features, and a model;
inputting the plurality of user features and the plurality of service provider features into the model;
updating the model to form an updated model;
determining a plurality of carts using the updated model, wherein each cart of the plurality of carts includes one or more items;
providing one or more carts of the plurality of carts to an end user device;
receiving a selection of a cart of the one or more carts or a modification thereof;
processing the selection by facilitating preparation and delivery of the one or more items in the cart; and
updating the updated model using data related to the cart to form a subsequent model.

13. The server computer of claim 12, wherein the server computer is a central server computer, wherein the plurality of user features includes order histories, addresses, and/or dietary preferences, wherein the plurality of service provider features include ratings, order rates, and/or item tags.

14. The server computer of claim 12, wherein processing the selection by facilitating preparation and delivery of the one or more items in the cart further comprises:
generating an order request message comprising the one or more items;
providing the order request message to a service provider computer associated with the one or more items for preparation of the one or more items;
determining a transporter user device of a plurality of transporter user devices based on a location of the transporter user device, an end user location, and a service provider location;
generating a delivery request message including the end user location and the service provider location;
providing the delivery request message to the transporter user device, wherein the transporter user device determines whether or not to accept to deliver the one or more items;
receiving a delivery response message indicating whether or not the transporter user device accepts to deliver the one or more items;
determining an updated location of the transporter user device; and
notifying the end user device of the updated location of the transporter user device.

15. The server computer of claim 12, wherein the model is a machine learning model that is trained using user features and service provider features, wherein after determining the plurality of carts, the method further comprises:
sorting each cart of the plurality of carts based on a relevance score that indicates how relevant each cart is to an end user of the end user device, wherein the relevance score for each cart of the plurality of carts is created by the updated model.

16. A method comprising:
providing, by an end user device, one or more user features to a server computer, wherein the server computer inputs the one or more user features and a plurality of service provider features into a model, updates the model to form an updated model, and determines a plurality of carts using the updated model, wherein each cart of the plurality of carts includes one or more items;
receiving, by the end user device, one or more carts of the plurality of carts from the server computer;
obtaining, by the end user device, a selection of a cart of the one or more carts or a modification thereof; and
providing, by the end user device, the selection of the cart to the server computer, wherein the server computer processes the selection by facilitating preparation and delivery of the one or more items in the cart and updates the updated model using data related to the cart to form a subsequent model.

17. The method of claim 16, wherein the modification thereof is a modified cart, wherein the method further comprises:
modifying, by the end user device, one cart of the one or more carts to create the modified cart.

18. The method of claim 17, wherein modifying the one cart of the one or more carts includes modifying the one or more items in the one cart.

19. The method of claim 16, wherein prior to receiving the one or more carts, the method further comprises:
generating, by the end user device, a cart request message; and
providing, by the end user device, the cart request message to the server computer.

20. The method of claim 16, wherein the data related to the cart includes user features and service provider features.
